(19) United States
(12) Patent Application Publication
(10) Pub. No.: US 2025/0172443 A1
(43) Pub. Date: May 29, 2025

(54) FORCE SENSING WITH ANALOG-TO-DIGITAL CONVERSION

(71) Applicant: CANON U.S.A., INC., Melville, NY (US)

(72) Inventor: Daisuke Yamada, Cambridge, MA (US)

(21) Appl. No.: 18/957,318

(22) Filed: Nov. 22, 2024

Related U.S. Application Data
(60) Provisional application No. 63/603,518, filed on Nov. 28, 2023.

(51) Int. Cl. G01L 1/22; G01L 5/22

(52) U.S. Cl. CPC G01L 1/2262; G01L 1/2212; G01L 1/2256; G01L 5/226

(57) ABSTRACT

An apparatus includes a controller; a bendable device having one or more bending segments, each bending segment being configured to bend, rotate, or translate by pulling or pushing a set of drive wires; an actuator device having a plurality of driving portions, each drive wire being connected to a driving portion, each driving portion having a driving source connected to a force sensor configured to detect force of the drive wire and generate an analog force signal in response to the detected force; one or more ADC, wherein the analog force signals of the set of drive wires are generated and communicated to a single ADC configured to convert the analog force signals to digital force signals, the digital force signals being serially communicated to the controller, wherein the controller drives the driving sources based on the digital force signals.

### CROSS-REFERENCE TO RELATED APPLICATIONS

This application claims the benefit of priority from U.S. Provisional Application No. 63/603,518, filed Nov. 28, 2023, which is hereby incorporated by reference herein in its entirety.

### BACKGROUND

### Field of the Disclosure

The present disclosure generally relates to force sensing mechanisms and, more particularly, to apparatuses, methods, and mediums for force sensing with analog-to-digital conversion.

### Description of the Related Art

Flexible or elongate tools, instruments, or other devices, e.g., catheters, endoscopes, colonoscopes, bronchoscopes, ablation devices, or other devices, can be used to look inside an object, where an instrument is passed through the tool to examine or treat an area in the object, such as a patient or the like.

A continuum robot, snake robot, robotic assembly, robotic catheter, robotic endoscope, snake endoscopic assembly, snake catheter assembly, or other types of assemblies are exemplary arrangements or configurations that can implement a flexible device to carry out medical procedures including imaging, diagnostic, endoscopic, biopsy, therapeutic, surgical, image guided therapy, or other procedures. Endoscopic procedures include colonoscopy (bowel), gastroscopy (stomach), cystoscopy (bladder), bronchoscopy (airways of the lung), laparoscopy (abdomen), and other types of procedures.

These configurations may have bendable structures equipped with operation wires and a rotational drive assembly to impart translational, rotational, or other types of movement to the operation wires of a steerable catheter, endoscope, or other flexible device. The drive assembly can be releasably connected to the catheter and a breakaway mechanism can be used so the drive assembly disconnects from the catheter in response to a breakaway force.

A robotic or snake catheter or endoscopic assembly, for example, can include a steerable catheter actuated with push-pull wires, a motorized actuator for driving catheter tip motions through the push-pull wires, and a controller that translates user/software commands into actuator motion, and other elements.

By actuating wires with both push and pull directions, tensile and contraction forces on the wires can lead to failure including wire anchor fracturing (wire anchors being the bonding mechanism between the wire and the catheter tip), wire prolapse and protrusion, and excessive lateral bending force to internal tissues such as lung tissues or the like. The wires may be broken at unexpected positions while the wires are released.

The robotic catheter or endoscope can include a flexible tubular shaft operated by an actuating force (pulling or pushing force) applied through drive wires arranged along the tubular shaft and controlled by an actuator unit. The flexible tubular shaft, steerable catheter, or continuum robot may include multiple articulated segments configured to continuously bend and turn in a snake-like fashion. Typically, the steerable catheter is inserted through a natural orifice or small incision of an object like a patient's body, and is advanced through a patient's bodily lumen to reach a target site, for example, a site within the patient's anatomy designated for an intraluminal procedure, such as an ablation or a biopsy. A handheld controller (e.g., a joystick or gamepad controller) may be used as an interface for interaction between a user and a robotic system to control catheter navigation within the patient's body.

The navigation of a steerable catheter can be guided by a live-view of a camera or videoscope arranged at the distal tip of the catheter shaft. To that end, a display device, such as a liquid crystal display (LCD) monitor provided in a system console or attached to a wall, displays an image of the camera's field of view (FOV image) to assist the user in navigating the steerable catheter through the patient's anatomy to reach the target site. The orientation of the camera view, the coordinates of the handheld controller, and the pose or shape of the catheter are mapped (calibrated) before inserting the catheter into the patient's body. As the user manipulates the catheter inside the patient's anatomy, the camera transfers the camera's FOV image to the display device. Ideally, the displayed image should allow the user to relate to the endoscopic image as if the user's own eyes were actually inside the endoscope cavity.

Robotic bronchoscopes as described above are increasingly used to screen patients for peripheral pulmonary lesions (PPL) related to lung cancer. See, for example, non-patent literature document 1 (NPL1), by Fielding, D., & Oki, M., “Technologies for targeting the peripheral pulmonary nodule including robotics”, Respirology, 2020, 25(9), 914-923, and NPL2 by Kato et al., “Robotized Catheter with Enhanced Distal Targeting for Peripheral Pulmonary Biopsy”, Published in: IEEE/ASME Transactions on Mechatronics (Volume: 26, pages 2451-2461, Issue: 5 Oct. 2021).

U.S. Provisional Application No. 63/310,415 filed Feb. 15, 2022 and International Application No. PCT/US23/13143 filed Feb. 15, 2023 also disclose mechanisms to monitor the force of each drive wire by using force sensors. The force signals are then delivered to a difference amplifier, and a control unit.

There are multiple (typically 2 or 3) drive wires for a single bending section of a catheter, and each drive wire has its own control unit to convert analog force signals to digital signals and acquire the digital signals to use the data for motor feedback controls.

Time losses occur when switching the control unit including an analog to digital converter (ADC) to acquire all force data of the single bending section, and the timing of the force data could be off. This makes time limitation to make the system faster.

There is a need to improve force data collection of bending segments of flexible bendable structures to minimize glitches when the force data is used for feedback control.

### SUMMARY

The present disclosure advantageously provides solutions to ensure that a controller can acquire multiple force data of a single bending segment of a flexible tool. By doing so, the controller can acquire force data of the single bending section simultaneously to minimize glitches when the force data is used for feedback control signals.

According to some embodiments, an apparatus may include a controller; a bendable device having one or more bending segments, each bending segment being configured to bend, rotate, or translate by pulling or pushing a set of drive wires; an actuator device having a plurality of driving portions, each drive wire being connected to a driving portion, each driving portion having a driving source connected to a force sensor configured to detect force of the drive wire and generate an analog force signal in response to the detected force; one or more ADC, wherein the analog force signals of the set of drive wires are generated and communicated to a single ADC configured to convert the analog force signals to digital force signals, the digital force signals being serially communicated to the controller, wherein the controller drives the driving sources based on the digital force signals.

The set of drive wires may be synchronized through the use of the single ADC. The apparatus may have a single ADC for each bending segment. The single ADC may be configured as a one chip ADC. One section of the bendable device with n bending segments with n force sensors may be communicable with one ADC, n being a number.

The set of drive wires may have two or three drive wires, where the two or three corresponding force signals generated by one ADC for the two or three drive wires are converted to the digital force signals in the one ADC. The ADC may be configured to serially transfer a set of the force data to the controller, where the set of the force data may include a set of digital force signals.

The bending segment may have a single bending segment and three ADCs, wherein each of the three ADCs processes the analog force signals corresponding to the single ending segment, the three ADCs being serially communicated to the controller, and the controller switches each ADC sequentially to read the force data.

The apparatus may have three bending segments and three ADCs, wherein each ADC processes the analog force signals corresponding to each bending segment, the three ADCs being serially communicated to the controller, and the controller switches each ADC sequentially to read the force data. The force sensor may have a Wheatstone bridge circuit.

The ADC may be configured to monitor and convert a reference voltage, the voltage being transferred to the controller for calibration, wherein the reference voltage is configured to determine a dynamic range of the analog to digital conversion.

The force sensor may generate a force sensor output that goes the ADC and the controller for each wire. Each driving source may include a motor controller that communicates to the controller via serial communication. The controller may be a single system controller.

According to some embodiments, an apparatus may include a controller; a flexible elongate device comprising one or more bending segments, each bending segment being configured to bend, rotate, or translate by pulling or pushing a set of a plurality of drive wires; an actuator device having a plurality of driving portions, each drive wire being connected to a driving portion, each driving portion comprising a driving source, a force sensor, a coupling portion, a drive wire being connected to the coupling portion, and the coupling portion being connected to the force sensor and the driving source; one or more analog to digital converter (ADC), wherein the force sensor is configured to generate an analog force signal in response to a force in each drive wire of the set of the plurality of drive wires, wherein the analog force signals of the set of the plurality of drive wires are transferred to one ADC, the one ADC being configured to convert the analog force signals to digital force signals, the digital force signals being serially communicated to the controller, and wherein the controller drives the driving sources based on the digital force signals.

The set of drive wires may be synchronized through the use of the one ADC. The apparatus may have a single ADC for each bending segment, wherein the single ADC may be configured as a one chip ADC. One section of the elongate flexible device may have n bending segments with n force sensors are communicable with a single ADC, n being a number.

The set of drive wires may have two or three drive wires, and the two or three corresponding force signals generated by the one ADC for the two or three drive wires may be converted to the digital force signals in the one ADC.

The one ADC may be configured to serially transfer a set of the force data to the controller, and the set of the force data may have a set of digital force signals. The flexible bending segment may have a single bending segment and three ADCs, wherein each ADC processes the analog force signals corresponding to the single ending segment, the three ADCs being serially communicated to the controller, and the controller switches each ADC sequentially to read the force data.

The flexible bending device may have three bending segments and three ADCs, wherein each of the three ADCs processes the analog force signals corresponding to each bending segment, the three ADCs being serially communicated to the controller, and the controller switches each ADC sequentially to read the force data. The force sensor may have a Wheatstone bridge circuit.

The one ADC may be configured to monitor and convert a reference voltage, the voltage being transferred to the controller for calibration, wherein the reference voltage is configured to determine a dynamic range of the analog to digital conversion.

The force sensor may generate a force sensor output that is communicable with the one ADC and the controller for each wire. Each driving source may have a motor controller that communicates to the controller via serial communication. The controller may be split to a robotic kinematics output and a motor controller.

Further features of the present disclosure will become apparent from the following description of exemplary embodiments with reference to the attached drawings, where like structure is indicated with like reference numerals.

### BRIEF DESCRIPTION OF THE DRAWINGS

FIG. 1 is a block diagram of an exemplary apparatus to ensure that a controller can acquire force data of a single bending segment of a flexible tool according to some embodiments.

FIG. 2 is a block diagram of a controller according to some embodiments.

FIG. 3 illustrates an exemplary apparatus environment to ensure that a controller can acquire force data of a single bending segment of a flexible tool according to some embodiments.

FIG. 4 is a functional block diagram of the apparatus of FIG. 3 according to some embodiments.

FIG. 5 is an operational diagram of the flexible device arranged as a continuum robot configuration according to some embodiments.

FIGS. 6A and 6B illustrate exemplary catheter tip manipulations according to some embodiments.

FIG. 7 is a logical block diagram of the flexible device arranged as a robotic catheter system according to some embodiments.

FIG. 8 is a schematic of a single bending segment according to some embodiments.

FIG. 9 is an ADC data acquisition time chart according to some embodiments.

FIG. 10 is a schematic of force control feedback for three bending segments according to some embodiments.

FIG. 11 is a schematic of three ADC data acquisition time chart for three bending segments according to some embodiments.

FIG. 12 is a schematic of an ADC circuit according to some embodiments. FIG. 13 is a schematic of an ADC circuit according to some embodiments.

FIG. 14 is a schematic of a single bending segment according to some embodiments, and an ADC data acquisition time chart according to some embodiments.

FIG. 15 is a schematic of a single bending segment according to some embodiments, and an ADC data acquisition time chart according to some embodiments.

### DESCRIPTION OF THE EMBODIMENTS

Various exemplary embodiments, features, and aspects of the disclosure that relate to apparatuses, methods, storage mediums, and other configurations to ensure that a controller can acquire force data of a single bending segment of a flexible tool so that the controller can minimize glitches when the force data is used for feedback control signals will be described below with reference to the drawings that may have different characteristics, advantages, disadvantages, performance parameters, or the like.

The present disclosure advantageously provides solutions to ensure that a robotic control system has a common analog to digital converter chip for multiple force data of a single bending segment. By doing so, the control system can acquire force data of the single bending section of the catheter simultaneously so that the system can minimize glitches when the force data is used for feedback control signals.

Some embodiments functionally implement continuum robot, snake robot, snake robotic assembly, snake endoscopic assembly, snake robotic catheter assembly, or other arrangements or configurations that can implement a flexible device to carry out medical procedures including imaging, diagnostic, endoscopic, biopsy, therapeutic, surgical, image guided therapy, or other procedures. Endoscopic procedures include colonoscopy (bowel), gastroscopy (stomach), cystoscopy (bladder), bronchoscopy (airways of the lung), laparoscopy (abdomen), and other types of procedures.

Some embodiments functionally implement imaging modalities including CT (computed tomography), MRI (magnetic resonance imaging), IVUS (intravascular ultrasound), PET (positron emission tomography), X-ray imaging, optical coherence tomography (OCT), swept source OCT (SS-OCT), optical frequency domain imaging (OFDI), Fourier domain OCT (FD-OCT), time domain OCT (TD-OCT), multi-modality OCT (MMOCT), spectrally encoded endoscopy (SEE), other imaging modalities, combinations or hybrids thereof. Arrangements can also functionally implement light detection and ranging (LiDAR) configurations that are used to measure distances to remote targets. The present disclosure is not limited to any particular configuration.

Swept source OCT is an OCT technique of acquiring the spectral distribution of the interference light by time division, and spectral domain OCT is an OCT technique of acquiring the spectral distribution of the interference light by space division.

In continuum robot or snake robotic configurational embodiments, for example, a flexible device such as a catheter, endoscope, or the like, can be controlled to navigate, insert, retract, roll, articulate, or combinations thereof based on inputs received manually, semi-automatically, automatically or combinations thereof. Flexible devices can include one or more wires or wire configurations including control wires, operation wires, drive wires, push wires, pull wires, push-pull wires, wire bundles, tendons, tendon wires, other wire configurations, or combinations thereof.

Controllable actuators can adjust the wires to adjust portions including the distal tip of the flexible device in any geometric or angular direction, e.g., up, down, left, right, translationally, rotationally, or combinations thereof.

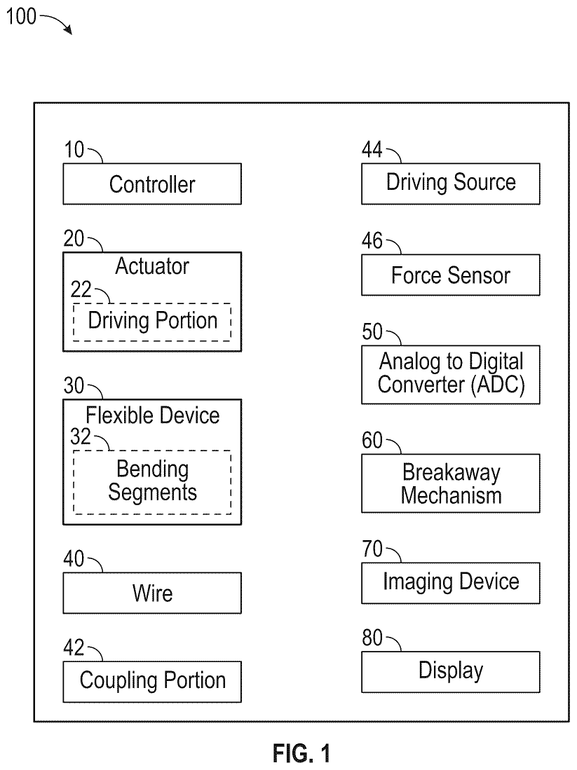

FIG. 1 illustrates an exemplary hardware configuration of an apparatus 100 to ensure that a controller 10 can acquire force data of a single bending segment of a flexible tool so that the controller 10 can minimize glitches when the force data is used for feedback control signals according to some embodiments.

The apparatus 100 includes one or more of the controller 10, an actuator 20, a flexible device 30, a wire 40, a coupling portion 42, a driving source 44, a force sensor 46, an analog to digital converter (ADC) 50, a breakaway mechanism 60, an imaging device 70, a display 80, and may include other components.

The controller 10 includes at least one processor, circuitry, or combinations thereof and is configured to operate to control all elements of the apparatus 10.

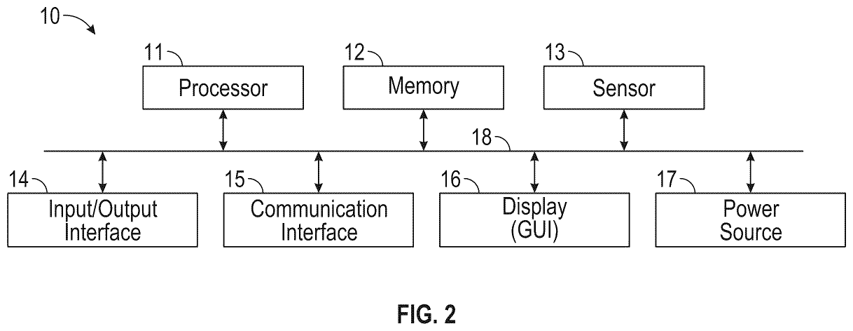

As shown in FIG. 2, the controller 10 has one or more configurational components that include one or more of a processor 11, a memory 12, a sensor 13, an input and output (I/O) interface 14, a communication interface 15, a display or graphical user interface (GUI) 16, a power source 17, and may include other components. The apparatus 10 may be interconnected with medical instruments or a variety of other devices, and may be controlled independently, externally, or remotely by the controller 12.

The processor 11 may be configured as a control circuit, circuitry, or combinations thereof (central processing unit (CPU), micro processing unit (MPU), or the like), for performing overall control of the apparatus 100, and may execute a program, instructions, code or software stored in the memory 12 to perform various data processing, computation, algorithmic tasks, or other functions of the apparatus 100. The memory 12 may store the program, software, computer instructions, information, other data, or combinations thereof. The memory 12 is used as a work memory. The processor 11 executes the software developed in the memory 12. The I/O interface 14 inputs the catheter positional information to the controller 10 and outputs information for displaying the navigation screen to the display 16. The power source 17 provides regulated power supply to the apparatus 100, and may include an external power source such as line power or alternating current (AC) power from a power outlet that may interconnect with the apparatus 100 through an alternating current to direct current (AC/DC) adapter and a DC/DC converter, or an AC/DC converter in order to adapt the power voltage from a source into one or more voltages used by components in the apparatus 100.

The display 16 may be a graphical user interface (GUI) or display device configured, for example, as a monitor, an LCD (liquid-crystal display), an LED (light-emitting diode) display, an OLED (organic LED) display, a plasma display, an organic electro luminescence panel, or the like. The controller 10 controls the display 16. Based on the control of the apparatus 100, a navigation screen may be displayed on the display 16 showing one or more images being captured, captured images, captured moving images recorded on the storage unit, or the like.

The components are connected together by a bus 18 so that the components may communicate with each other. The bus 18 transmits and receives data between these pieces of hardware connected together, or transmits a command from the processor 11 to the other pieces of hardware. The components may be implemented by one or more physical devices that may be coupled to the processor 11 through the communication interface 15 to a communication channel. For example, the controller 10 may be implemented using circuitry in the form of ASIC (application specific integrated circuits) or the like. Alternatively, the controller 10 may be implemented as a combination of hardware and software, where the software is loaded into a processor from a memory or over a network connection. Functionality of the controller 10 may be stored on a storage medium, which may include random access memory (RAM), read-only memory (ROM), magnetic or optical drive, diskette, cloud storage, or the like.

The actuator 20 may include one or more driving portions 22 motors and may drive components of the apparatus 100. The flexible device 30 may include one or more bending segments 32 and is configured to examine or treat an area in an object, such as a patient or the like. The wire 40 may include one or more wires or wire configurations including control wires, operation wires, drive wires, push wires, pull wires, push-pull wires, wire bundles, tendons, tendon wires, other wire configurations, or combinations thereof. The coupling portion 42 is configured connect the wire 40 to other components of the apparatus 10 including, for example, the actuator 20, the driving source 44, the force sensor 46, or other components. The driving source 44 is configured to drive components of the apparatus 100 and may include one or more motors and may operate in connection with the actuator 20.

The force sensor 46 is configured to measure push and pull forces on the wire 40, and can detect translational force or movement along the X-axis, Y-axis, Z-axis, and separately detect rotational force or motion around a yaw-axis, a pitch-axis, roll-axis, or other directions. The force sensor 46 can include an opto-sensor, force/torque sensor, or other type of sensor, that enables the apparatus 10 to respond electromechanically to movement of the wire 40.

The force sensor 46 may include one or more or a combination of a processor, detection circuitry, memory, hardware, software, firmware, and can include other circuitry, elements, or components. The force sensor 46 may be a plurality of sensors and acquires sensor information output from one or more sensors that detect force, motion, current position and movement of components interconnected with the apparatus 100. The sensor 46 may include a multi-axis acceleration or accelerometer sensor and a multi-axis gyroscope sensor, may be a combination of an acceleration and gyroscope sensors, may include other sensors, and may be configured through the use of a piezoelectric transducer, a mechanical switch, a single axis accelerometer, a multi-axis accelerometer, or other types of configurations. The sensor 46 can monitor, detect, measure, record, or store physical, operational, quantifiable data or other characteristic parameters of the apparatus 10 including one or more or a combination of a force, impact, shock, drop, fall, movement, acceleration, deceleration, velocity, rotation, temperature, pressure position, orientation, motion, or other types of data of the apparatus 10 directionally in multiple axes, in a multi-dimensional manner, along the X-axis, Y-axis, Z-axis, or any combination thereof, and can generate sensor readings, information, data, a digital signal, an electronic signal, or other types of information corresponding to the detected state.

The apparatus 100 can transmit or send the sensor reading data wirelessly or in a wired manner to a remote host or server. The sensor 46 may be interrogated and can generate a sensor reading signal or information that can be processed in real time, stored, post processed at a later time, or combinations thereof. The information or data that is generated by the sensor 46 can be processed, demodulated, filtered, or conditioned to remove noise or other types of signals. The sensor 46 may include one or more or a combination of a force sensor, an acceleration, deceleration, or accelerometer sensor, a gyroscope sensor, a power sensor, a battery sensor, a proximity sensor, a motion sensor, a position sensor, a rotation sensor, a magnetic sensor, a barometric sensor, an illumination sensor, a pressure sensor, an angular position sensor, a temperature sensor, an altimeter sensor, an infrared sensor, a sound sensor, an air monitoring sensor, a piezoelectric sensor, a strain gauge sensor, a sound sensor, a vibration sensor, a depth sensor, and may include other types of sensors.

The ADC 50 is configured as a data converter to interconnect analog and digital circuitry and convert between analog signals and digital signals. The breakaway mechanism 60 is configured to disconnect the actuator 20 from the flexible device 30 in response to a breakaway force. The imaging device 70 may be mechanical, digital, electrical, or combinations thereof, and is configured to record, store, or transmit visual images. The display 80 may be a GUI or a display device configured, for example, to display operational information about the apparatus 100 including informational and analytical data, medical information, medical imagery, captured images, captured moving images, other types of information, or combinations thereof. The display 80 may be configured, for example, as a monitor, an LCD, an LED display, an OLED display, a plasma display, an organic electro luminescence panel, or the like. The controller 10 controls the display 80. Based on the control of the apparatus 100, a navigation screen may be displayed on the display 80 showing one or more images being captured, captured images, captured moving images recorded on the storage unit, or the like.

The set of drive wires may be synchronized through the use of the one ADC. The apparatus may have a single ADC for each bending segment, wherein the single ADC may be configured as a one chip ADC. One section of the elongate flexible device may have n bending segments with n force sensors are communicable with a single ADC, n being a number.

The set of drive wires may have two or three drive wires, and the two or three corresponding force signals generated by the one ADC for the two or three drive wires may be converted to the digital force signals in the one ADC.

The one ADC may be configured to serially transfer a set of the force data to the controller, and the set of the force data may have a set of digital force signals. The flexible bending segment may have a single bending segment and three ADCs, wherein each ADC processes the analog force signals corresponding to the single ending segment, the three ADCs being serially communicated to the controller, and the controller switches each ADC sequentially to read the force data.

The flexible bending device may have three bending segments and three ADCs, wherein each of the three ADCs processes the analog force signals corresponding to each bending segment, the three ADCs being serially communicated to the controller, and the controller switches each ADC sequentially to read the force data. The force sensor may have a Wheatstone bridge circuit.

The one ADC may be configured to monitor and convert a reference voltage, the voltage being transferred to the controller for calibration, wherein the reference voltage is configured to determine a dynamic range of the analog to digital conversion.

The force sensor may generate a force sensor output that is communicable with the one ADC and the controller for each wire. Each driving source may have a motor controller that communicates to the controller via serial communication. The controller may be split to a robotic kinematics output and a motor controller.

The apparatus 100 may include other components including, for example, a wire clamping mechanism, a linear sliding mechanism, and may include other components.

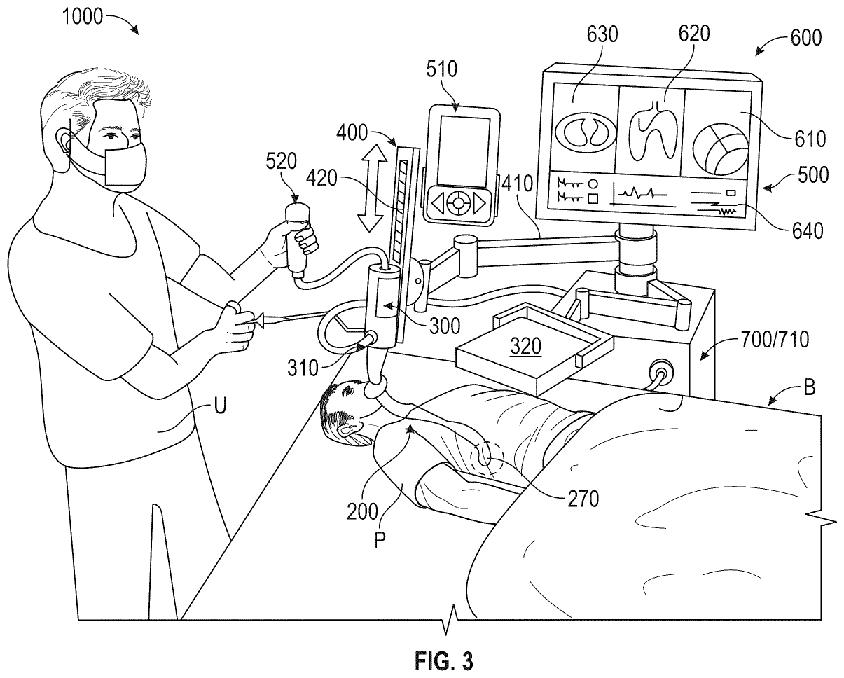

FIG. 3 illustrates an exemplary apparatus or configuration 1000 to ensure that a controller can acquire force data of a single bending segment of a flexible tool so that the controller can minimize glitches when the force data is used for feedback control signals according to some embodiments.

### Robotic Catheter System

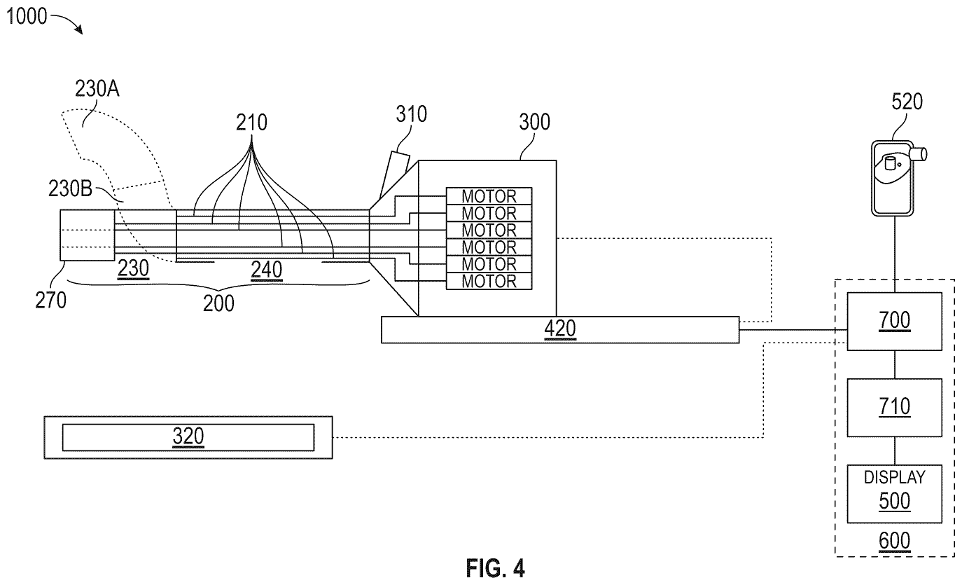

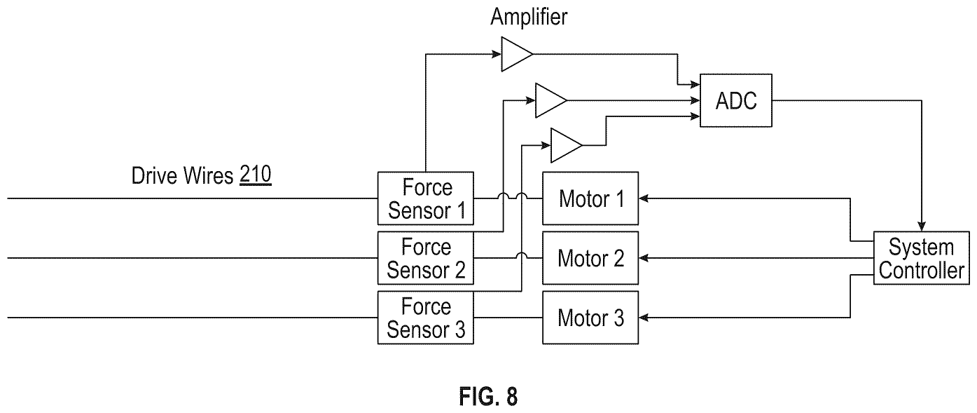

An exemplary embodiment of a robotic catheter system 1000 is described in reference to FIG. 3 through FIG. 7. FIG. 3 illustrates a simplified representation of a medical environment, such as an operating room, where a robotic catheter system 1000 is illustrated and other arrangements may be used. FIG. 4 illustrates a functional block diagram of the robotic catheter system 1000. FIG. 7 illustrates a logical block diagram of the robotic catheter system 1000.

In this example, the robotic catheter system 1000 includes a system console 600 (computer cart) operatively connected to a steerable catheter 200 via a robotic platform 400. The robotic platform 400 includes one or more than one robotic arm 410 and a linear translation stage 420. A steerable catheter 200 and an actuator 300 are interconnected to the robotic platform 400 with the one or more robotic arms 410.

The system 1000 includes an interface unit (operation unit) to perform an operational procedure on an object, for example, an intraluminal procedure or the like on a patient P positioned on an operating table B. The user interface may include one or more of a first user interface unit 500, e.g., a first or main display, a second user interface unit 510, e.g., a second or secondary display, a third user interface unit 520, e.g., a handheld controller or the like, or combinations thereof, and may include other user interface units.

The main display 500 may include a large display screen attached to the system console 600 or mounted on a wall of the operating room. The secondary display 600 may include a compact (portable) display device configured to be removably attached to the robotic platform 400. Examples of the secondary display 510 may include a portable tablet computer, a mobile communication device (a cellphone), or other components.

The steerable catheter 200 is actuated via an actuator unit 300. The actuator unit 300 is attached to the linear translation stage 420 of the robotic platform 400. The handheld controller 520 may include a gamepad controller with a joystick having shift levers and/or push buttons. In one embodiment, the actuator unit 300 is enclosed in a housing having a shape of a catheter handle. An access port 310 is provided in or around the catheter handle. The access port 310 is used for inserting and/or withdrawing end effector tools and/or fluids when performing an interventional procedure of the patient.

The system console 600 includes a system controller 700, a display controller 710, and the main display 600. The main display 600 may include a conventional display device such as a liquid crystal display (LCD), an OLED display, a QLED display or the like. The main display 600 provides a graphical interface unit (GUI) configured to display one or more of a live view image 610, an intraoperative image 620, and a preoperative image 630, and other procedural information 640. The preoperative image 630 may include pre-acquired multi-dimensional medical images of the patient, e.g., two-dimensional (2D), three-dimensional (3D), or the like, acquired by imaging modalities such as computer tomography (CT), magnetic resonance imaging (MRI), ultrasound imaging, or other imaging modalities. The intraoperative image 620 may include images used for image guided procedure such images may be acquired by fluoroscopy, CT imaging, or other imaging modalities. The intraoperative image 630 may be augmented, combined, or correlated with information obtained from a catheter tip position detector 320 and catheter tip tracking sensor 270. The catheter tip tracking sensor 270 may include an electromagnetic (EM) sensor, and the catheter tip position detector 320 may include an EM field generator operatively connected to the system controller 100. Suitable electromagnetic sensors for use with a steerable catheter are well-known and described, for example, in U.S. Pat. No. 6,201,387 and international publication WO2020194212A1, and other types of sensors can be used.

Similar to FIG. 3, the diagram of FIG. 4 illustrates the robotic catheter system 1000 includes the system controller 700 operatively connected to the display controller 710, to the actuator unit 300 via the linear translation stage 420, and to the tip position detector 320. The tip position detector 320 is at a position spatially related to a three-dimensional space where the catheter tip tracking sensor 270 operates. In this manner, the tip position detector 320 is able to track the functional position of the steerable catheter 200.

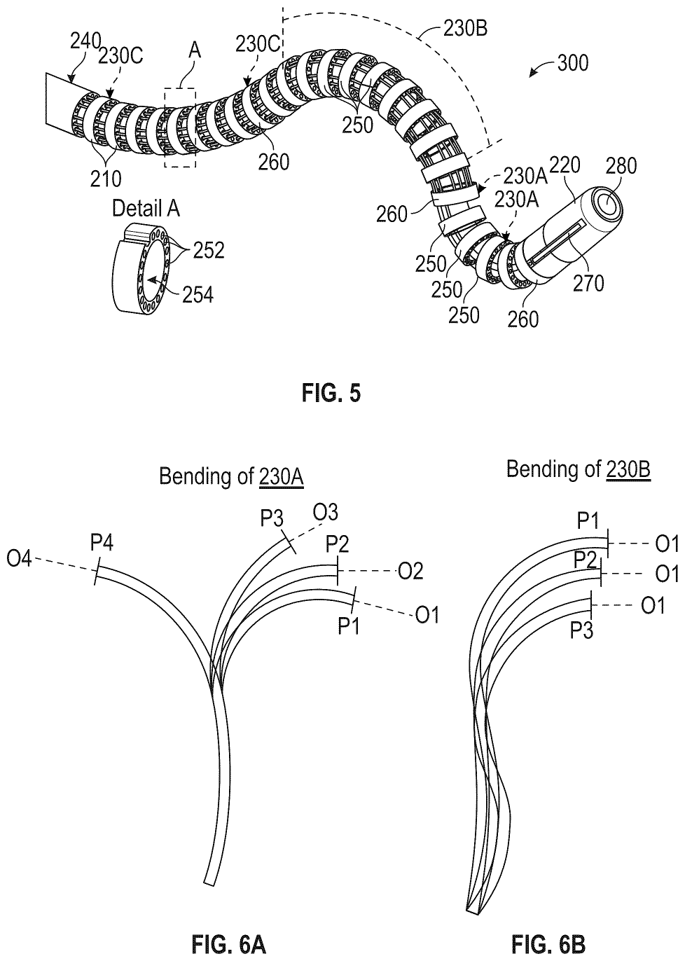

FIG. 5 shows an exemplary embodiment of a steerable catheter 200. The steerable catheter 200 includes a non-steerable proximal section 240, a steerable distal section 230, and a catheter tip 220. The proximal section 240 and distal section 230 are joined to each other by a plurality of drive wires 210 arranged along the wall of the catheter. The proximal section 240 is configured with thru-holes or grooves or conduits to pass drive wires 210 from the distal section 230 to the actuator unit 300. The distal section 230 can include a plurality of bending segments including, for example, a distal bending segment 230A, a middle bending segment 230B, a proximal bending segment 230C, and can include other segments. Each bending segment is bent by actuation of at least some of the plurality of drive wires 210 (driving members). The posture of the catheter 200 can be supported by non-illustrated supporting wires (support members) also arranged along the wall of the catheter 200. The proximal ends of drive wires 210 are connected to individual actuators or motors of the actuator unit 300, while the distal ends of the drive wires 210 are selectively anchored to anchor members in the different bending segments of the distal section 230.

Each bending segment is formed by a plurality of ring-shaped components (rings) with thru-holes, grooves, or conduits along the wall of the rings. The ring-shaped components are defined as wire-guiding members 250 or anchor members 260 depending on their function within the catheter. Anchor members 260 are ring-shaped components onto which the distal end of one or more drive wires 210 are attached. Wire-guiding members 250 are ring-shaped components through which some drive wires 210 slide through (without being attached thereto).

Detail “A” in FIG. 5 illustrates an exemplary embodiment of a ring-shaped component (a wire-guiding member 250 or an anchor member 260). Each ring-shaped component includes a central opening which forms the tool channel 252, and plural conduits 254 (grooves, sub-channels, or thru-holes) arranged lengthwise equidistant from the central opening along the annular wall of each ring-shaped component. The non-steerable proximal section 240 is a flexible tubular shaft made of extruded polymer material. The tubular shaft of the proximal section 240 also has a central opening or tool channel 252 and plural conduits 254 along the wall of the shaft surrounding the tool channel 252. In this manner, at least one tool channel 252 formed inside the steerable catheter 200 provides passage for an imaging device and/or end effector tools from the insertion port 310 to the distal end of the steerable catheter 200.

An imaging device 280 may be inserted through the tool channel 252 can include an endoscope camera (videoscope) along with illumination optics (e.g., optical fibers or LEDs). The illumination optics provide light to irradiate a lesion target which is a region of interest within the patient. The imaging device 280 may be mechanical, digital, electrical, or combinations thereof, and is configured to record, store, or transmit visual images. End effector tools refer endoscopic surgical tools including clamps, graspers, scissors, staplers, ablation or biopsy needles, and can include other similar tools, which serve to manipulate body parts (organs or tumorous tissue) during examination or surgery.

The actuator unit 300 can include one or more servo motors or piezoelectric actuators. The actuator unit 300 bends one or more of the bending segments of the catheter by applying a pushing and/or pulling force to the drive wires 210. As shown in FIG. 5, each of the three bendable segments of the steerable catheter 104 has a plurality of drive wires 210. If each bendable segment is actuated by three drive wires 210, the steerable catheter 200 has nine driving wires arranged along the wall of the catheter. Each bendable segment of the catheter is bent by the actuator unit 300 by pushing or pulling at least one of these nine drive wires 210. Force is applied to each individual drive wire in order to manipulate/steer the catheter to a desired pose. The actuator unit 300 assembled with steerable catheter 200 is mounted on the linear translation stage 320. Linear translation stage 320 includes a slider and a linear motor. In other words, the linear translation stage 320 can be motorized, and can be controlled by the system controller 100 to insert and remove the steerable catheter 200 to/from the object or, for example, a patient's bodily lumen.

The force sensor 46 can detect a tension applied to the driving wire 40. The sensed signal can be transmitted to the controller 10 and the controller 10 can control the actuator 20 based on the sensed signal. The force sensor 46 can measure comprsession force, tensile force, shear force, normal force, force in translation, force in rotation, or other types of force. The force sensor 46 can have various configurations including, for example, contact force, tactile force, piezoelectric, piezoresistive, fiber-optic, magnetic, or other types of configurations.

The actuator device 300 can include one or more force sensors between the drive wires 210 and the motors/actuators 300 in order to monitor compression and tensile forces to the driver wires 210. When external forces are applied to the catheter 200 such as pushing against the patient's organs, the force can be delivered to the force sensors 46 via the drive wires 210. The force sensor 46 can be made with strain gauges, which are converted from force into a change in electrical resistance. These strain gauges can be arranged in a Wheatstone Bridge circuit to detect changes in electrical resistance with high sensitivity. When applying an excitation voltage to the bridge circuits, the changes in electrical resistance can be detected as a voltage change. The amplifier can also be applied to the voltage change to increase the voltage level (analog force signal) for better signal to noise ration of analog to digital conversion. Then, the analog force signals can be delivered to the system controller 100 after converting to digital signals.

The system controller 700 can control the motors or actuators for the drive wires 210 to minimize the analog force signals (force feedback control). To minimize the analog force signals, the bending segments of the catheter 200 bends in response to the external forces. The catheter 200 can be robotically controlled in a flexible manner like a soft tube, e.g. a relax mode. The user or operator can change the navigation mode to the relax mode to release the external forces to the catheter and/or minimize the force against the patient's organ.

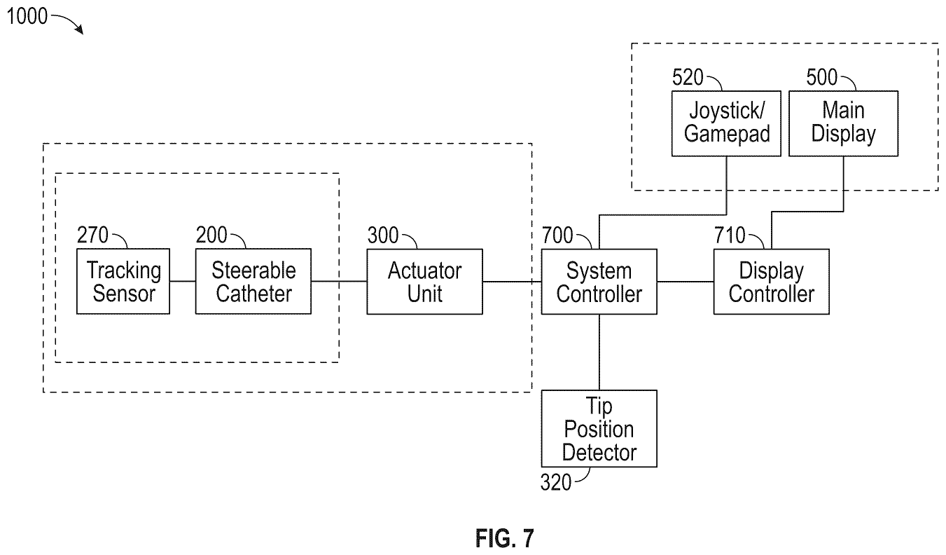

FIG. 6A illustrates a schematic of the force control feedback for a single bending segment. In this example, the bending segment has three drive wires. The plurality of analog force signals, three for this example, corresponding to a single bending segment of the catheter are delivered to a single analog-to-digital converter (ADC) via amplifiers. The ADC can synchronize signals from the drive wires and send analog force signals acquired at approximately the same time to the system controller 700. The ADC ensures data captured from different analog signals are aligned in time, effectively capturing the phase relationship between them. The force data 1, 2 and 3 from the force sensors 1, 2 and 3 can serially transfer to the system controller 700 as a set of packets, so that there will no data transfer or loss/delay time between force data 1, 2 and 3, as shown in FIG. 6B.

FIGS. 6A and 6B show exemplary catheter tip manipulations by actuating one or more bending segments of the steerable catheter 200. As illustrated in FIG. 6A, manipulating only the most distal segment 230A of the steerable section changes the position and orientation of the catheter tip 220. On the other hand, manipulating one or more bending segments (230B or 230C) other than the most distal segment affects only the position of catheter tip 220, but does not affect the orientation of the catheter tip 200. In FIG. 5, actuation of distal segment 230A changes the catheter tip from a position P1 having orientation O1, to a position P2 having orientation O2, to position P3 having orientation O3, to position P4 having orientation O4, etc. In FIG. 6B, actuation of the middle segment 230B changes the position of catheter tip 220 from a position P1 having orientation O1 to a position P2 and position P3 having the same orientation O1. Here, it should be appreciated by those skilled in the art that exemplary catheter tip manipulations shown in FIG. 6A and FIG. 6B can be performed during catheter navigation (i.e., while inserting the catheter 200 through tortuous anatomies). In the present disclosure, the exemplary catheter tip manipulations shown in FIGS. 6A and FIG. 6B apply namely to the targeting mode applied after the catheter tip 220 has been navigated to a predetermined distance (a targeting distance) from the target.

FIG. 7 illustrates a logical block diagram of the robotic catheter system 1000. The tracking sensor 270 (e.g., an EM tracking sensor) is attached to the catheter tip 220. In this embodiment, steerable catheter 200 and the tracking sensor 270 can be tracked by the tip position detector 320. Specifically, the tip position detector 320 detects a position of the tracking sensor 270, and outputs the detected positional information to the system controller 700. The system controller 700 receives the positional information from the tip position detector 320, and continuously records and displays the position of the steerable catheter 200 with respect to the patient's coordinate system. The system controller 700 controls the actuator device 300 and the linear translation stage 420 in accordance with the manipulation commands input by the user U via one or more of the user interface units (the handheld controller 520, a GUI at the main display 500 or touchscreen buttons at the secondary display 510).

The system controller 700 in FIG. 7 calculates movements based on the input of the force signals and commands the movements to motors. By using the plurality analog force signals with a single common ADC, the system can use simultaneous force data from a single bending segment, so that the system can minimize the glitches when the force data is used for force control feedback. By using a single common ADC, the feedback control loop can make with higher sampling rate because the acquisition does not need to switch between several ADC chips.

### First Embodiment

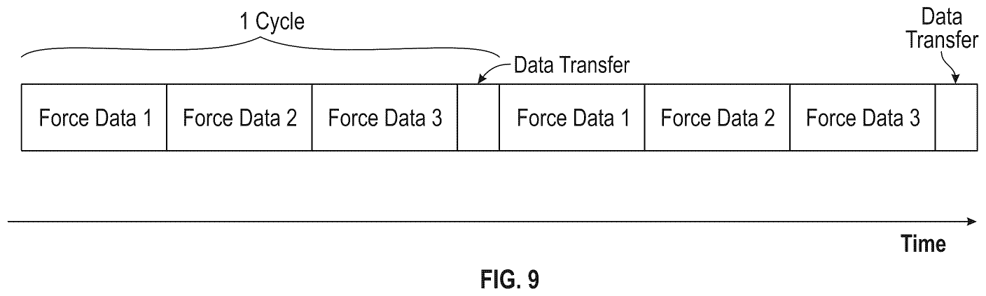

In the first embodiment, FIG. 8 is a schematic of a single bending segment, force control feedback. In FIG. 8, three drive wires 210 are driven by motors 1, 2, 3 and forces on the drive wires 210 are detected by force sensors 1, 2, 3. The force sensors 1, 2, 3 generate three separate analog force signals based on the detected forces corresponding to a single bending segment of the catheter, that are delivered to a single ADC via amplifiers. The ADC sends analog force signals acquired at approximately the same time to the system controller 900. The force data 1, 2 and 3 from the force sensors 1, 2 and 3 can serially transfer to the system controller as a set of packets, so that there will no data transfer or loss/delay time between force data 1, 2 and 3, as shown in FIG. 6B.

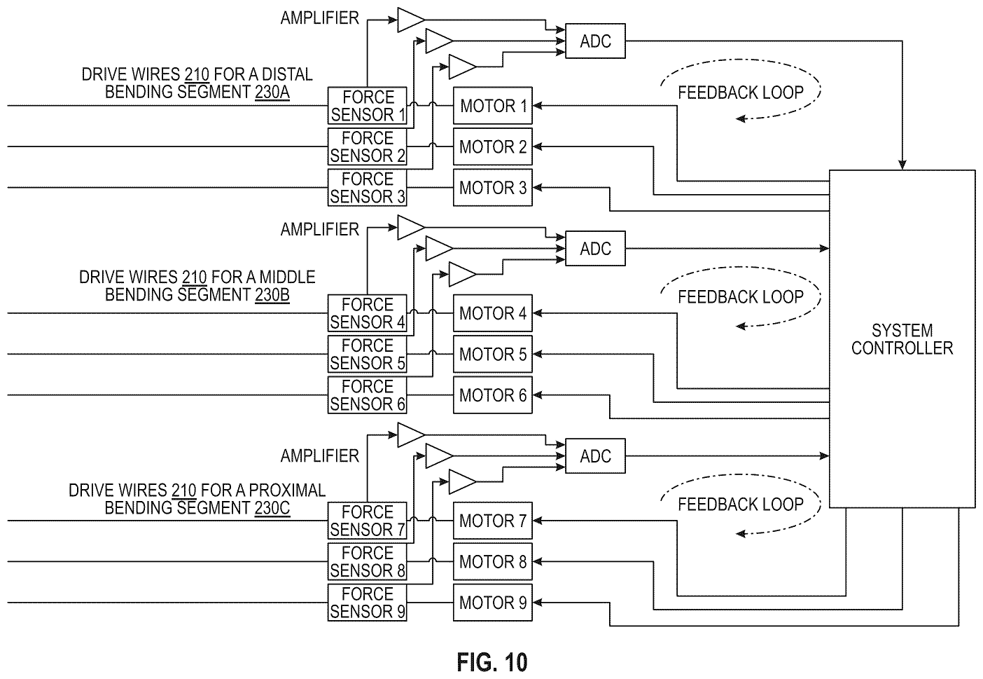

FIG. 9 is an ADC data acquisition time chart illustrating the serial transfer of force data 1, 2, 3 from the force sensors 1, 2, 3 to the system controller 700 as a set of packets in each cycle.

In case the distal section 230 is comprised of a plurality of bending segments including at least a distal bending segment 230A, a middle bending segment 230B, and a proximal bending segment 230C, the force signals from force sensors of each bending segment 230A, 230B, 230C are transferred to a single ADC so there are three separate ADCs for the distal bending segment 230A, the middle bending segment 230B and the proximal bending segment 230C. The feedback loop frequency becomes faster to have a single ADC for each bending segment 230A, 230B, 230C, and each ADC data can send to the system controller 700 with a little delay, shown in FIG. 9, so that the system controller 700 efficiently process the motor commands for each bending segment 230A, 230B, 230C.

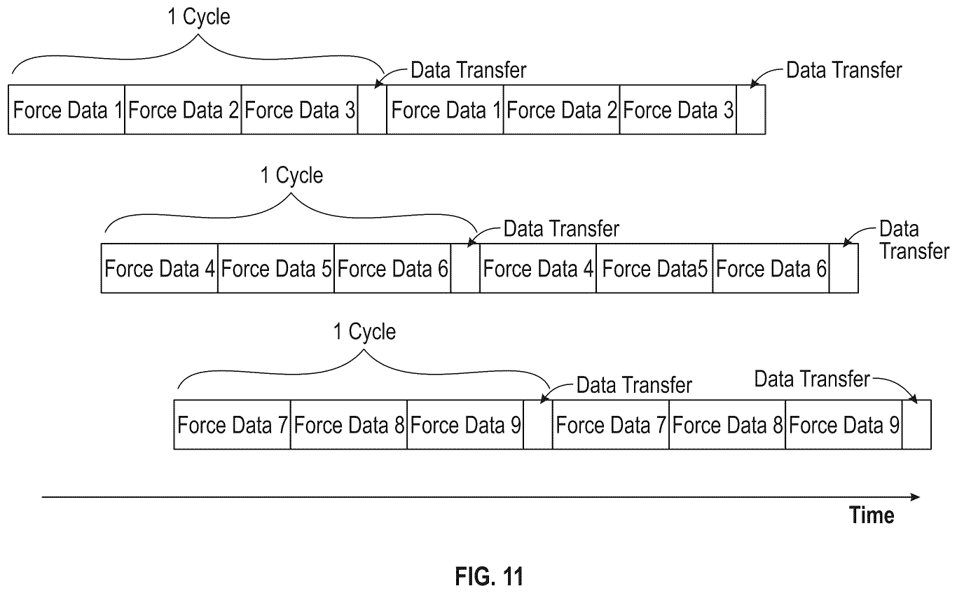

FIG. 10 is a schematic of a bending segment, force control feedback for the three bending segments of the catheter, e.g., the distal bending segment 230A, the middle bending segment 230B, and the proximal bending segment 230C.

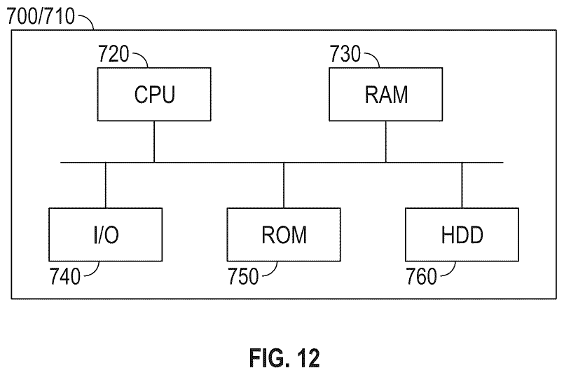

FIG. 11 is an ADC data acquisition time chart illustrating the serial transfer of force data 1, 2, 3 from the force sensors 1, 2, 3 of the distal bending segment 230A to the system controller as a set of packets in each cycle, the serial transfer of force data 4, 5, 6 from the force sensors 4, 5, 6 of the middle bending segment 230B to the system controller as a set of packets in each cycle, and the serial transfer of force data 7, 8, 9 from the force sensors 7, 8, 9 of the proximal bending segment 230C to the system controller as a set of packets in each cycle.

The distal bending segment 230A has three drive wires 210 driven by motors 1, 2, 3 and forces on the drive wires 210 are detected by force sensors 1, 2, 3. The force sensors 1, 2, 3 generate three separate analog force signals based on the detected forces corresponding to the distal bending segment of the catheter, that are delivered to a single ADC via amplifiers. The ADC for the distal bending segment 230A sends analog force signals acquired at approximately the same time to the system controller 700. The force data 1, 2 and 3 from the force sensors 1, 2 and 3 can serially transfer to the system controller 700 as a set of packets, so that there will no data transfer or loss/delay time between force data 1, 2 and 3.

The middle bending segments 230B has three drive wires 210 driven by motors 4, 5, 6 and forces on the drive wires 210 are detected by force sensors 4, 5, 6. The force sensors 4, 5, 6 generate three separate analog force signals based on the detected forces corresponding to the middle bending segment of the catheter, that are delivered to a single ADC via amplifiers. The ADC for the middle bending segment sends analog force signals acquired at approximately the same time to the system controller 700. The force data 4, 5, 6 from the force sensors 4, 5, 6 can serially transfer to the system controller as a set of packets, so that there will no data transfer or loss/delay time between force data 4, 5, 6.

The proximal bending segments 130C has three drive wires 210 driven by motors 7, 8, 9 and forces on the drive wires 210 are detected by force sensors 7, 8, 9. The force sensors 7, 8, 9 generate three separate analog force signals based on the detected forces corresponding to the proximal bending segment of the catheter, that are delivered to a single ADC via amplifiers. The ADC for the proximal bending segment sends analog force signals acquired at approximately the same time to the system controller 700. The force data 7, 8, 9 from the force sensors 7, 8, 9 can serially transfer to the system controller as a set of packets, so that there will no data transfer or loss/delay time between force data 7, 8, 9.

The system controller 700 executes software programs and controls the display controller 910 to display a navigation screen (e.g., a live view image 610) on the main display 500 and/or the secondary display 510. The display controller 710 may include a graphics processing unit (GPU) or a video display controller (VDC). The display controller 102 generates a three-dimensional (3D) model of an anatomical structure (for example a branching structure like the airway of a patient's lungs) based on preoperative or intraoperative images such as CT or MRI images, etc. Alternatively, the 3D model may be received by the system console from another device (e.g., a picture archiving and communication system (PACS) sever or other device). A two-dimensional (2D) model can be used instead of 3D model. In this case, the display controller 102 may process (through segmentation) a preoperative 3D image to acquire slice images (2D images) of a patient's anatomy. The images can be stored in a digital imaging and communications in medicine (DICOM) or another file format so they can be accessed and reviewed. The 2D or 3D model can be generated before catheter navigation starts. Alternatively, the 2D or 3D model can be generated in real-time (in parallel with the catheter navigation). In one embodiment, an example of generating a model of a branching structure is explained later. However, the model is not limited to a model of branching structure. For example, a model of a route direct to a target (a tumor or nodule or tumorous tissue) can be used instead of the branching structure. Alternatively, a model of a broad space can be used for catheter navigation. The model of broad space can be a model of a place or a space where an observation or a task is performed by using the robotic catheter, as further explained below.

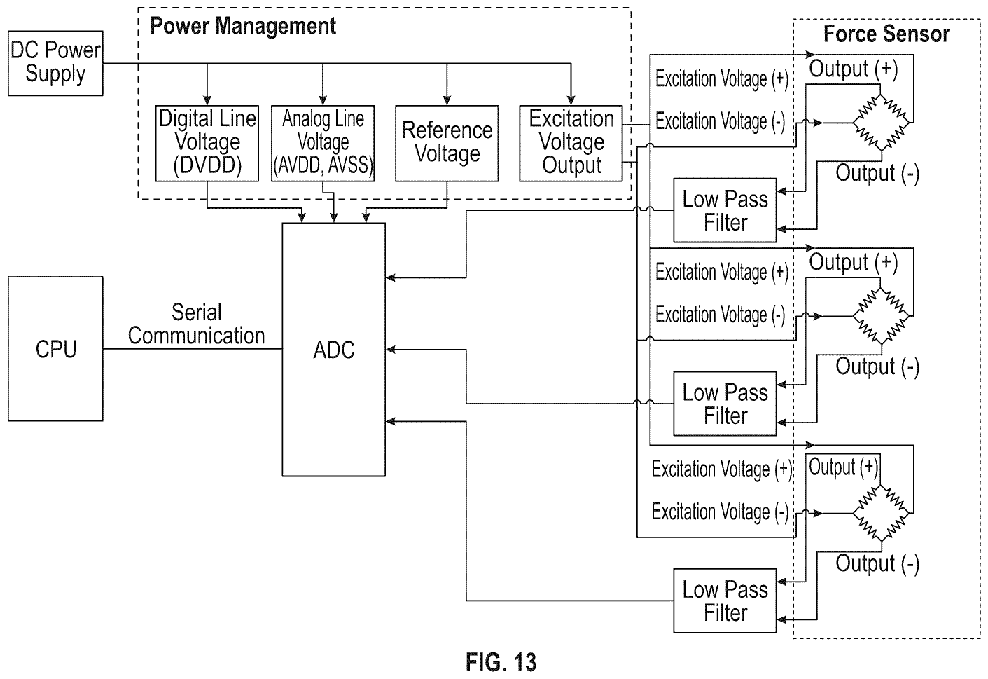

FIG. 12 illustrates components of the system controller 700 and/or the display controller 710. The system controller 700 and the display controller 710 can be configured separately. Alternatively, the system controller 700 and the display controller 710 can be configured as one device. In either case, the system controller 700 and the display controller 710 comprise substantially the same components. Specifically, the system controller 700 and display controller 710 may include a central processing unit (CPU 720) comprised of one or more processors (microprocessors), a random-access memory (RAM 730), an input/output (I/O 740) interface, a read only memory (ROM 9750), and data storage memory (e.g., a hard disk drive (HDD 760) or solid-state drive (SSD)). The system controller 700 and display controller 710 may include a plurality of different types of processors and memories as desired.

The ROM 750 and/or HDD 760 store the operating system (OS) software, and software programs for executing the functions of the robotic catheter system 1000 as a whole. The RAM 730 is used as a workspace memory. The CPU 720 executes the software programs developed in the RAM 730. The I/O 740 inputs, for example, positional information to the display controller 710, and outputs information for displaying the navigation screen to the one or more displays (main display 500 and/or secondary display 510). In the embodiments descried below, the navigation screen is a graphical user interface (GUI) generated by a software program but, it may also be generated by firmware, or a combination of software and firmware.

The system controller 700 may control the steerable catheter 200 based on any known kinematic algorithms applicable to continuum or snake-like catheter robots. For example, the system controller controls the steerable catheter 104 based on an algorithm known as follow the leader (FTL) algorithm. By applying the FTL algorithm, the most distal segment 230A of the steerable section 230 is actively controlled with forward kinematic values, while the middle segment 230B and the proximal segment 230C (following sections) of the steerable catheter 200 move at a first position in the same way as the distal section moved at the first position or a second position near the first position.

The display controller 710 acquires position information of the steerable catheter 200 from system controller 700. Alternatively, the display controller 710 may acquire the position information directly from the tip position detector 270. The steerable catheter 200 may be a single-use or limited-use catheter device. In other words, the steerable catheter 200 can be attachable to, and detachable from, the actuator device 300 to be disposable.

During a procedure, the display controller 710 generates and outputs a live-view image or a navigation screen to the main display 500 and/or the secondary display 510 based on the 3D model of a patient's anatomy (a branching structure) and the position information of at least a portion of the catheter 200 (e.g., position of the catheter tip 220) by executing pre-programmed software routines. The navigation screen indicates a current position of at least the catheter tip 220 on the 3D model. By observing the navigation screen, a user can recognize the current position of the steerable catheter 200 in the branching structure. Upon completing navigation to a desired target, one or more end effector tools can be inserted through the access port 310 at the proximal end of the catheter 200, and such tools can be guided through the tool channel of the catheter body to perform an intraluminal procedure from the distal end 220 of the catheter 200.

The tool may be a medical tool such as an endoscope camera, forceps, a needle or other biopsy or ablation tools. In one embodiment, the tool may be described as an operation tool or working tool. The working tool is inserted or removed through the working tool access port 310. In the embodiments below, an embodiment of using a steerable catheter to guide a tool to a target is explained. The tool may include an endoscope camera or an end effector tool, which can be guided through a steerable catheter under the same principles. In a procedure there is usually a planning procedure, a registration procedure, a targeting procedure, and an operation procedure.

### Second Embodiment

In the second embodiment, FIG. 13 illustrates a schematic of an ADC circuit, and the ADC circuits for the force sensors are further described. The ADC circuit comprises of a power management segment, an ADC chip, and a signal filter segment. The power management segment includes power supplies/linear regulator to generate a digital line voltage (DVDD), analog line voltages (AVDD, AVSS), reference voltages, and excitation voltages for force sensors. DVDD is the digital voltage level of the ADC chip, AVDD and AVSS defines the input analog voltage range, and reference voltage defines the dynamic range of the analog to digital conversion. The excitation voltages are supplied to the force sensors, and the voltage signals from the force sensors to go through low pass filters to eliminate high frequency noises, then the signals are delivers to a single ADC chip. Then, the ADC chip communicate to a master CPU by a serial communication protocol.

In this example, the signals from the three force sensors are delivered to a single ADC chip. The ADC sends analog force signals acquired at approximately the same time to the CPU. The force data from the force sensors can serially transfer to the CPU as a set of packets, so that there will no data transfer or loss/delay time between force data. The CPU uses the force data as a part of feedback control loop so that the controller can minimize the glitches. The feedback control loop can make with higher sampling rate because the acquisition does not require switching the ADC chips.

The force sensors can be configured in the form of one or more strain gauge load cells, for example, or other types of force sensors. In a case where force is applied to the strain gauge, the shape can change and cause the resistance in the strain gauge to change or be altered. The applied force can be measured by reading the change in voltages to configure the strain gauge resistors, where there would be four balanced strain gauge resistors for a Wheatstone bridge circuitry configuration.

The ADC chip can monitor excitation voltage output. The signal levels of the force sensor are proportional to the excitation voltage output so that the system can calibrate the fluctuations of the output by monitoring the output. The system could have better accuracy force data.

The ADC chip can monitor reference voltages. The digital value after ADC digital conversion refers to the reference voltages. When the reference voltages have fluctuations, the system can calibrate/compensate the value by using the monitored reference voltages. By using the same ADC chip, the board can eliminate other noise sources.

In the second embodiment, the feedback control system by using force sensors has a common ADC (analog to digital converter) chip. The control system can acquire force data of the single bending segment of the catheter simultaneously so that the system can minimize glitches when the force data is used for feedback control signals.

### Third Embodiment

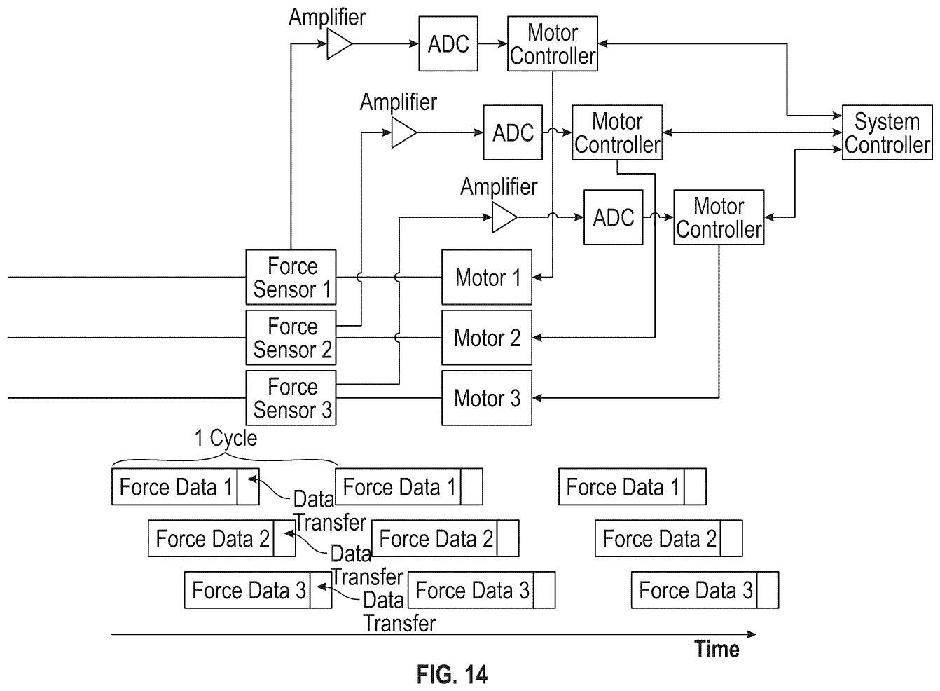

In the third embodiment, FIG. 14 is a configurational schematic of a single bending segment, force control feedback. In FIG. 14, three drive wires are driven by motors 1, 2, 3 and forces on the drive wires are detected by force sensors 1, 2, 3. The force sensors 1, 2, 3 generate three separate analog force signals based on the detected forces corresponding to a single bending segment of the catheter, that are delivered to a single ADC via amplifiers. The ADC sends analog force signals acquired at approximately the same time to the system controller 100. The force data 1, 2 and 3 from the force sensors 1, 2 and 3 can serially transfer to the system controller as a set of packets, so that there will no data transfer or loss/delay time between force data 1, 2 and 3.

Each force sensor output goes to each ADC and the motor controller for each wire. Each motor has its own motor controller that communicates to the system controller via serial communication. The serial communication for the motors can be common. The system controller of the configuration of the third embodiment is a single system controller.

At the bottom of FIG. 14, an ADC data acquisition time chart illustrates the serial transfer of force data 1, 2, 3 from the force sensors 1, 2, 3 to the system controller as a set of packets in each cycle.

### Fourth Embodiment

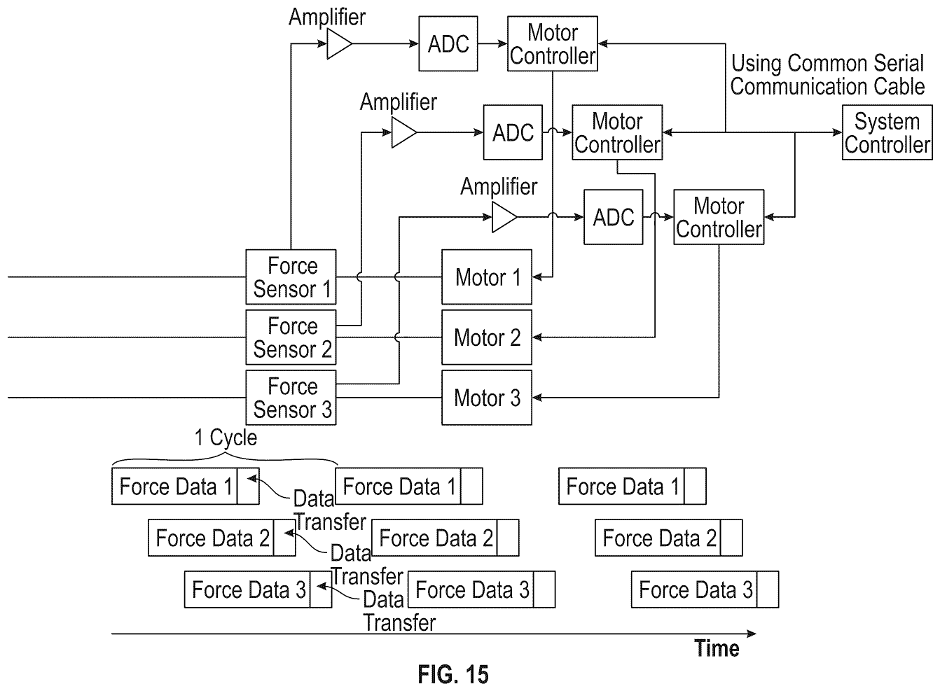

In the fourth embodiment, FIG. 15 is a configurational schematic of a single bending segment, force control feedback. In FIG. 15, three drive wires are driven by motors 1, 2, 3 and forces on the drive wires are detected by force sensors 1, 2, 3. The force sensors 1, 2, 3 generate three separate analog force signals based on the detected forces corresponding to a single bending segment of the catheter, that are delivered to a single ADC via amplifiers. The ADC sends analog force signals acquired at approximately the same time to the system controller 100. The force data 1, 2 and 3 from the force sensors 1, 2 and 3 can serially transfer to the system controller as a set of packets, so that there will no data transfer or loss/delay time between force data 1, 2 and 3.

Each force sensor output goes to each ADC and the motor controller for each wire. Each motor has its own motor controller that communicates to the system controller via serial communication. The serial communication for the motors can be common. The system controller of the configuration of the fourth embodiment of FIG. 15 may include more than one system controller. Instead of the single system controller shown in FIG. 14, the system controller of the fourth embodiment may include a robotic kinematics output and motor controllers, and the system controller may be split to the system controller (robot kinematics output) and motor controllers.

In FIG. 15, an ADC data acquisition time chart illustrates the serial transfer of force data 1, 2, 3 from the force sensors 1, 2, 3 to the system controller as a set of packets in each cycle.

The sensor output of each force sensor 1, 2, 3 in FIG. 14 goes to each ADC and the motor controller. Instead of a single system controller,

In case the distal section 230 is comprised of a plurality of bending segments including at least a distal bending segment 230A, a middle bending segment 230B, and a proximal bending segment 230C. The force signals from force sensors of each bending segment are transferred to a single ADC so there are three separate ADCs for the distal bending segment 230A, the middle bending segment 130B and the proximal bending segment 230C. The feedback loop frequency becomes faster to have a single ADC for each bending segment, and each ADC data can send to the system controller with a little delay, shown in FIG. 9, so that the system controller efficiently processes the motor commands for each bending segment.

### Advantages

The robotic control system can acquire force data of the single bending segment of the catheter simultaneously so that the system can minimize glitches when the force data is used for feedback control signals.

1 Robotic control system may comprise the following components.

A catheter unit detachably attached to an actuation unit, the catheter unit including one or more than 2 bending segments.

Each bending segment is driven to bend by pulling or pushing a set of drive wires.

Each drive wire connected to a coupling portion in an actuator unit.

The actuator unit including plurality of driving portions.

Each driving portion including a single driving source, a single force sensor and the single coupling portion, the single drive wire connected to the single coupling portion, and the single coupling portion connected to the single force sensor and the single driving source.

The force sensor generates a analog force signal to response in the force of the drive wire.

The analog force signals of the set of drive wires are connected to a single ADC unit, the ADC unit convert the analog force signals to digital force signals, the digital force signals are serially communicated to a robot controller unit.

The robotic control unit drives the driving source based on the digital force signals.

2. A set of drive wires are 2 or 3, and the 2 or 3 analog force signals are converted to the digital force signals in the single ADC.

3. The ADC serially transfer a set of the force data to a robot controller, and the set of the packet includes the set of digital force signals.

4. Bending segments are 3, and there are 3 ADCs, and each ADC process the analog force signals corresponding each bending segment. 3 ADCs are serially communicated to the robot controller, and the robot controller switches ADC sequentially to read the force data.

5. The force sensor can be a Wheatstone bridge circuit.

6. The ADC can monitor and convert an excitation voltage that is transferred to the robot control unit for calibration. The excitation voltage is applied to the force sensor.

7. The ADC can monitor and convert a reference voltage that is transferred to the robotic control unit for calibration. The reference voltage is used to determine a dynamic range of the analog to digital conversion.

The present disclosure describes how the robotic control system has a common ADC (analog to digital converter) circuit or chip for multiple force data of a single bending segment. By doing so, the control system can acquire force data of the single bending section of the catheter simultaneously so that the system can minimize glitches when the force data is used for feedback control signals.

According to some embodiments, an apparatus can include a controller; a bendable device having one or more bending segments, each bending segment being configured to bend, rotate, or translate by pulling or pushing a set of drive wires; an actuator device having a plurality of driving portions, each drive wire being connected to a driving portion, each driving portion having a driving source connected to a force sensor configured to detect force of the drive wire and generate an analog force signal in response to the detected force; one or more ADC, wherein the analog force signals of the set of drive wires are generated and communicated to a single ADC configured to convert the analog force signals to digital force signals, the digital force signals being serially communicated to the controller, wherein the controller drives the driving sources based on the digital force signals.

The set of drive wires may be synchronized through the use of the single ADC. The apparatus may have a single ADC for each bending segment. The single ADC may be configured as a one chip ADC. One section of the bendable device with n bending segments with n force sensors can be communicable with one ADC, n being a number.

The set of drive wires may have two or three drive wires, where the two or three corresponding force signals generated by one ADC for the two or three drive wires are converted to the digital force signals in the one ADC. The ADC may be configured to serially transfer a set of the force data to the controller, where the set of the force data can include a set of digital force signals.

The bending segment may have a single bending segment and three ADCs, wherein each of the three ADCs processes the analog force signals corresponding to the single ending segment, the three ADCs being serially communicated to the controller, and the controller switches each ADC sequentially to read the force data.

The apparatus may have three bending segments and three ADCs, wherein each ADC processes the analog force signals corresponding to each bending segment, the three ADCs being serially communicated to the controller, and the controller switches each ADC sequentially to read the force data. The force sensor may have a Wheatstone bridge circuit.

The ADC may be configured to monitor and convert a reference voltage, the voltage being transferred to the controller for calibration, wherein the reference voltage is configured to determine a dynamic range of the analog to digital conversion.

The force sensor may generate a force sensor output that goes the ADC and the controller for each wire. Each driving source may include a motor controller that communicates to the controller via serial communication. The controller may be a single system controller.

According to some embodiments, an apparatus can include a controller; a flexible elongate device comprising one or more bending segments, each bending segment being configured to bend, rotate, or translate by pulling or pushing a set of a plurality of drive wires; an actuator device having a plurality of driving portions, each drive wire being connected to a driving portion, each driving portion comprising a driving source, a force sensor, a coupling portion, a drive wire being connected to the coupling portion, and the coupling portion being connected to the force sensor and the driving source; one or more analog to digital converter (ADC), wherein the force sensor is configured to generate an analog force signal in response to a force in each drive wire of the set of the plurality of drive wires, wherein the analog force signals of the set of the plurality of drive wires are transferred to one ADC, the one ADC being configured to convert the analog force signals to digital force signals, the digital force signals being serially communicated to the controller, and wherein the controller drives the driving sources based on the digital force signals.

The set of drive wires may be synchronized through the use of the one ADC. The apparatus may have a single ADC for each bending segment, wherein the single ADC may be configured as a one chip ADC. One section of the elongate flexible device may have n bending segments with n force sensors are communicable with a single ADC, n being a number.

The set of drive wires may have two or three drive wires, and the two or three corresponding force signals generated by the one ADC for the two or three drive wires may be converted to the digital force signals in the one ADC.

The one ADC may be configured to serially transfer a set of the force data to the controller, and the set of the force data may have a set of digital force signals. The flexible bending segment may have a single bending segment and three ADCs, wherein each ADC processes the analog force signals corresponding to the single ending segment, the three ADCs being serially communicated to the controller, and the controller switches each ADC sequentially to read the force data.

The flexible bending device may have three bending segments and three ADCs, wherein each of the three ADCs processes the analog force signals corresponding to each bending segment, the three ADCs being serially communicated to the controller, and the controller switches each ADC sequentially to read the force data. The force sensor may have a Wheatstone bridge circuit.

The one ADC may be configured to monitor and convert a reference voltage, the voltage being transferred to the controller for calibration, wherein the reference voltage is configured to determine a dynamic range of the analog to digital conversion.

The force sensor may generate a force sensor output that is communicable with the one ADC and the controller for each wire. Each driving source may have a motor controller that communicates to the controller via serial communication. The controller may be split to a robotic kinematics output and a motor controller.

Additional features or aspects of present disclosure can also advantageously implement one or more AI (artificial intelligence) or machine learning algorithms, processes, techniques, or the like, to ensure that a controller can acquire force data of a single bending segment of a flexible tool so that the controller can minimize glitches when the force data is used for feedback control signals. Such AI techniques use a neural network, a random forest algorithm, a cognitive computing system, a rules-based engine, or the like, and are trained based on a set of data to assess types of data and generate output. For example, a training algorithm can be configured to ensure that a controller can acquire force data of a single bending segment of a flexible tool so that the controller can minimize glitches when the force data is used for feedback control signals. The model(s) can be configured as software that takes images as input and returns predictions for the given images as output. The model(s) can be an instance of a model architecture (set of parameter values) that has been obtained by model training and selection using a machine learning and/or optimization algorithm/process. A model can generally include, for example, an architecture defined by a source code (e.g., a convolutional neural network including layers of parameterized convolutional kernels and activation functions, or the like) and configuration values (parameters, weights, features, or the like) that are initially set to random values and are then over the course of the training iteratively optimized given data example, an objective function (loss function), an optimization algorithm (optimizer), or the like.

At least some of the positional movement or orientation of actuator and other components to ensure that a controller can acquire force data of a single bending segment of a flexible tool so that the controller can minimize glitches when the force data is used for feedback control signals can be used as input data and provided to the training algorithm. Initial positional movement or orientation of the medical device can be stored in a database to facilitate precision centering of the fiber core relative to the ferrule outside diameter that are generated using input mapping to the model(s) or through expert research, and machine learning can find parameters for AI processes. Initial positional movement or orientation of the medical device are used or placed into an AI process or algorithm to facilitate precision modeling to accommodate various types of medical procedures, treatment, diagnostics, or another use. The training algorithm is configured to learn physical relationships in the input data to best describe these relationships or correlations. The data sets include information based on a number of factors including, for example, the positional movement or orientation of actuator and other components to ensure that a controller can acquire force data of a single bending segment of a flexible tool so that the controller can minimize glitches when the force data is used for feedback control signals, or the like. The data is evaluated using a weighted evaluation where the weights are learned through a training process, through subject matter specifications, or the like. Deep learning mechanisms can augment an AI process to accommodate various types of positional sensing and breakaway configurations, or another use.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

### Other Embodiments

Embodiment(s) of the present disclosure can also be realized by a computerized configuration(s) of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computerized configuration(s) of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computerized configuration(s) may comprise one or more processors, one or more memories, circuitry, or a combination thereof (e.g., central processing unit (CPU), micro processing unit (MPU), or the like), and may include a network of separate computers or separate processors to read out and execute the computer executable instructions. The computer executable instructions may be provided to the computerized configuration(s), for example, from a network or the storage medium. The storage medium may include, for example, one or more of a hard-disk, a random-access memory (RAM), a read only memory (ROM), a storage of distributed computing systems, an optical disk (such as a compact disc (CD), digital versatile disc (DVD), or Blu-ray Disc (BD)™M), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An apparatus comprising:
a controller;
a bendable device having one or more bending segments, each bending segment being configured to bend, rotate, or translate by pulling or pushing a set of drive wires;
an actuator device having a plurality of driving portions, each drive wire being connected to a driving portion, each driving portion having a driving source connected to a force sensor configured to detect force of the drive wire and generate an analog force signal in response to the detected force;
one or more analog to digital converter (ADC),
wherein the analog force signals of the set of drive wires are generated and communicated to a single ADC configured to convert the analog force signals to digital force signals, the digital force signals being serially communicated to the controller,
wherein the controller drives the driving sources based on the digital force signals.

2. The apparatus according to claim 1, wherein the set of drive wires are synchronized through the use of the single ADC.

3. The apparatus according to claim 1, further comprising a single ADC for each bending segment.

4. The apparatus according to claim 1, wherein the single ADC is configured as a one chip ADC.

5. The apparatus according to claim 1, wherein one section of the bendable device with n bending segments with n force sensors are communicable with one ADC, n being a number.

6. The apparatus according to claim 1, wherein the set of drive wires comprises two or three drive wires, and the two or three corresponding force signals generated by one ADC for the two or three drive wires are converted to the digital force signals in the one ADC.

7. The apparatus according to claim 1, wherein the ADC is configured to serially transfer a set of the force data to the controller, and the set of the force data comprises a set of digital force signals.

8. The apparatus according to claim 1, wherein the bending segment comprises a single bending segment and three ADCs, wherein each of the three ADCs processes the analog force signals corresponding to the single ending segment, the three ADCs are serially communicated to the controller, and the controller switches each ADC sequentially to read the force data.

9. The apparatus according to claim 1, wherein the apparatus comprises three bending segments and three ADCs, wherein each ADC processes the analog force signals corresponding to each bending segment, the three ADCs being serially communicated to the controller, and the controller switches each ADC sequentially to read the force data.

10. The apparatus according to claim 1, wherein the force sensor comprises a Wheatstone bridge circuit.

11. The apparatus according to claim 1, wherein the ADC is configured to monitor and convert a reference voltage, the voltage being transferred to the controller for calibration, wherein the reference voltage is configured to determine a dynamic range of the analog to digital conversion.

12. The apparatus according to claim 1, wherein the force sensor generates a force sensor output that goes the ADC and the controller for each wire.

13. The apparatus according to claim 1, wherein each driving source comprises a motor controller that communicates to the controller via serial communication.

14. The apparatus according to claim 1, wherein the controller is a single system controller.

15. An apparatus comprising:
a controller;
a flexible elongate device comprising one or more bending segments, each bending segment being configured to bend, rotate, or translate by pulling or pushing a set of a plurality of drive wires;
an actuator device having a plurality of driving portions, each drive wire being connected to a driving portion, each driving portion comprising a driving source, a force sensor, a coupling portion, a drive wire being connected to the coupling portion, and the coupling portion being connected to the force sensor and the driving source;
one or more analog to digital converter (ADC),
wherein the force sensor is configured to generate an analog force signal in response to a force in each drive wire of the set of the plurality of drive wires,
wherein the analog force signals of the set of the plurality of drive wires are transferred to one ADC, the one ADC being configured to convert the analog force signals to digital force signals, the digital force signals being serially communicated to the controller,
wherein the controller drives the driving sources based on the digital force signals.

16. The apparatus according to claim 15, wherein the set of drive wires are synchronized through the use of the one ADC.

17. The apparatus according to claim 15, further comprising a single ADC for each bending segment.

18. The apparatus according to claim 17, wherein the single ADC is configured as a one chip ADC.

19. The apparatus according to claim 15, wherein one section of the elongate flexible device with n bending segments with n force sensors are communicable with a single ADC, n being a number.

20. The apparatus according to claim 15, wherein the set of drive wires comprises two or three drive wires, and the two or three corresponding force signals generated by the one ADC for the two or three drive wires are converted to the digital force signals in the one ADC.

21. The apparatus according to claim 15, wherein the one ADC is configured to serially transfer a set of the force data to the controller, and the set of the force data comprises a set of digital force signals.

22. The apparatus according to claim 15, wherein the flexible bending segment comprises a single bending segment and three ADCs, wherein each ADC processes the analog force signals corresponding to the single ending segment, the three ADCs are serially communicated to the controller, and the controller switches each ADC sequentially to read the force data.

23. The apparatus according to claim 15, wherein the flexible bending device comprises three bending segments and three ADCs, wherein each of the three ADCs processes the analog force signals corresponding to each bending segment, the three ADCs being serially communicated to the controller, and the controller switches each ADC sequentially to read the force data.

24. The apparatus according to claim 15, wherein the force sensor comprises a Wheatstone bridge circuit.

25. The apparatus according to claim 1, wherein the one ADC is configured to monitor and convert a reference voltage, the voltage being transferred to the controller for calibration, wherein the reference voltage is configured to determine a dynamic range of the analog to digital conversion.

26. The apparatus according to claim 15, wherein the force sensor generates a force sensor output that is communicable with the one ADC and the controller for each wire.

27. The apparatus according to claim 15, wherein each driving source comprises a motor controller that communicates to the controller via serial communication.

28. The apparatus according to claim 15, wherein the controller is split to a robotic kinematics output and a motor controller.
